(19) United States
(12) Patent Application Publication
(10) Pub. No.: US 2021/0201501 A1
(43) Pub. Date: Jul. 1, 2021

(54) MOTION-BASED OBJECT DETECTION METHOD, OBJECT DETECTION APPARATUS AND ELECTRONIC DEVICE

(71) Applicant: HANGZHOU EYECLOUD TECHNOLOGIES CO., LTD., Hangzhou, Zhejiang (CN)

(72) Inventors: Po YUAN, San Jose, CA (US); Shengjun PAN, Sichuan (CN); Junneng ZHAO, Hangzhou, Zhejiang (CN); Daniel MARINIUC, GIROC, TIMIS (RO)

(21) Appl. No.: 16/078,253

(22) PCT Filed: Jun. 29, 2018
(86) PCT No.: PCT/CN2018/093697

§ 371 Date: Aug. 21, 2018

(51) Int. Cl. G06T 7/20; G06K 9/00; G06N 3/02

(52) U.S. Cl. CPC G06T 7/20; G06K 9/00771; G06T 2207/20084; G06N 3/02; G06K 9/00744

(57) ABSTRACT

A motion-based object detection method includes the steps of extracting, by processing acquired first and second images, one or more regions of interest (ROIs); transforming the one or more ROIs into grayscale; and acquiring, by processing the grayscale ROIs with a deep neural network (DNN) model to classify the objects contained in the one or more ROIs, a classification result of whether the objects contained in the one or more ROIs belong to a given categories. The DNN model comprises N (N is a positive integer and ranged from 4-12) depthwise separable convolution layers. each depthwise separable convolution layer comprises a depthwise convolution layer for applying a single filter to each input channel and a pointwise layer for creating a linear combination of the outputs of the depthwise convolution layer to obtain feature maps of the grayscale ROIs.

### CROSS REFERENCE TO RELATED APPLICATIONS

This application the U.S. National Phase Application under 35 U.S.C. § 371 of International Application No. PCT/CN2018/093697, filed Jun. 29, 2018, the entire disclosure of which is hereby incorporated by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT DISCLOSURE

### Field

The present disclosure relates to a machine vision, and more particularly to a motion-based object detection method, object detection apparatus and electronic device.

### Description of Related Arts

Humans can usually quickly recognize the categories of an object based on domain knowledge. In the information technology era, automatic object detection or recognition by machine vision has become widely desired. For example, a surveillance camera may integrate with an object recognition computer program to promptly distinguish potential intruders by differentiating an object of interest (i.e. people) from inanimate background.

In recent years, deep neural networks (DNNs), such as conventional neural network, have gained greater popularity in object detection with higher accuracy than conventional algorithms. For example, many DNN algorithms have been developed for offline object detection in static images. However, just as the DNN models for offline object detection in static images, present focus of DNN has been to make deeper and more complicated networks in order to achieve higher accuracy. It is well known that most accuracy breakthroughs are paid off with higher computation cost, i.e. the ResNet neural network which has a hierarchical network structure.

Such trend is not conducive for the promotion of DNN in embedded terminals. The reasons are mainly as follows: First, the computational capability of most embedded chips for embedded terminal product is not that strong that the DNN would occupy vast part of bandwidth and computation resources, even if cloud computing is taken into consideration; Secondly, the deadly desire for embedded terminal product is to have low latency and lower consumption, while the accuracy merely needed to be kept in an acceptable range.

Therefore, there is an urgent desire for an object detection method and computer program product thereof which can be applied to embedded platforms.

### SUMMARY OF THE PRESENT DISCLOSURE

The disclosure is advantageous in that it provides a motion-based object detection method, object detection apparatus and electronic device, which has a low power consumption and achieves an effective tradeoff between latency and accuracy by gray processing the image to be detected and constructing a specific DNN model.

According to one aspect of the present disclosure, it provides a motion-based object detection method which comprises the following steps.

Extract, by processing acquired first and second images, one or more regions of interest (ROIs).

Transform the one or more ROIs into grayscale.

Acquire, by processing the grayscale ROIs with a deep neural network (DNN) model to classify the objects contained in the one or more ROIs, a classification result of whether the objects contained in the one or more regions belong to a given categories, wherein the DNN model comprises N (N is a positive integer and ranged from 4-12) depthwise separable convolution layers, wherein each depthwise separable convolution layer comprises a depthwise convolution layer for applying a single filter to each input channel and a pointwise layer for linearly combining the outputs of the depthwise convolution layer to obtain feature maps of the grayscale ROIs.

In one embodiment of the present disclosure, the step of acquiring a classification result comprises the following steps.

Determine any one of the objects contained in the one or more ROIs belonging to the given categories; and

Generate, responsive to the determination, an indication of a presence of the objects contained in the one or more ROIs belonging to the given categories.

In one embodiment of the present disclosure, the step of extracting the one or more ROIs comprises the following steps.

Identify different image regions between the first image and the second image.

Group the different image regions between the first image and the second image into the one or more ROIs.

In one embodiment of the present disclosure, prior to identifying the different image regions between the first image and the second image, the method further comprises a step of transforming the second image to compensate for the physical movement of a image collecting apparatus when capturing the first and second images.

In one embodiment of the present disclosure, the first and second images are two consecutive frames of a video.

In one embodiment of the present disclosure, the one or more ROIs are scaled to size 128*128 pixels.

In one embodiment of the present disclosure, the DNN model comprise five depthwise separable convolution layers.

According to another aspect of the present disclosure, it further provides an object detection apparatus which is an data processing device for object detection, comprising:

a region of interest (ROI) extracting module for extracting, by processing acquired first and second images, one or more regions of interest (ROIs);

a grayscale transformation module for transforming the one or more ROIs into grayscale; and

a classification result acquiring module for acquiring, by processing the grayscale ROIs with a deep neural network (DNN) model to classify the objects contained in the one or more ROIs, a classification result of whether the objects contained in the one or more ROIs belong to a given categories, wherein the DNN model comprises N (N is a positive integer and ranged from 4-12) depthwise separable convolution layers, wherein each depthwise separable convolution layer comprises a depthwise convolution layer for applying a single filter to each input channel and a pointwise layer for linearly combining the outputs of the depthwise convolution layer to obtain feature maps of the grayscale ROIs.

In one embodiment of the present disclosure, the classification result acquiring module is further arranged for determining whether any one of the objects contained in the one or more ROIs belongs to the given categories and generating, responsive to the determination, an indication of a presence of the objects contained in the one or more ROIs belonging to the given categories.

In one embodiment of the present disclosure, the region of interest extracting module is further arranged for identifying different image regions between the first image and the second image and grouping the different image regions between the first image and the second image into the one or more ROIs.

In one embodiment of the present disclosure, the region of interest extracting module is further arranged for transforming the second image to compensate for a physical movement of an image collecting apparatus when capturing the first and second images.

In one embodiment of the present disclosure, the first and second images are two consecutive frames of a video.

In one embodiment of the present disclosure, the one or more ROIs are scaled to size 128*128 pixels.

In one embodiment of the present disclosure, the DNN model comprise five depthwise separable convolution layers.

According to another aspect of the present disclosure, it further provides an electronic device, comprising a processor; and a computer-readable storage media, wherein program instructions are stored on the computer-readable storage device, the stored program instructions comprising:

program instructions to extract, by processing acquired first and second images, one or more regions of interest (ROIs);

program instructions to transform the one or more ROIs into grayscale; and

program instructions to acquire, by processing the grayscale ROIs with a deep neural network (DNN) model to classify the objects contained in the one or more ROIs, a classification result of whether the objects contained in the one or more regions belong to a given categories, wherein the DNN model comprises N (N is a positive integer and ranged from 4-12) depthwise separable convolution layers, wherein each depthwise separable convolution layer comprises a depthwise convolution layer for applying a single filter to each input channel and a pointwise layer for linearly combining the outputs of the depthwise convolution layer to obtain feature maps of the grayscale ROIs.

According to another aspect of the present disclosure, A computer program product, comprising one or more computer-readable storage device and program instructions stored on the computer-readable storage device, wherein the stored program instructions comprising:

program instructions to extract, by processing acquired first and second images, one or more regions of interest (ROIs);

program instructions to transform the one or more ROIs into grayscale; and

program instructions to acquire, by processing the grayscale ROIs with a deep neural network (DNN) model to classify the objects contained in the one or more ROIs, a classification result of whether the objects contained in the one or more regions belong to a given categories, wherein the DNN model comprises N (N is a positive integer and ranged from 4-12) depthwise separable convolution layers, wherein each depthwise separable convolution layer comprises a depthwise convolution layer for applying a single filter to each input channel and a pointwise layer for linearly combining the outputs of the depthwise convolution layer to obtain feature maps of the grayscale ROIs.

Still further objects and advantages will become apparent from a consideration of the ensuing description and drawings.

These and other objectives, features, and advantages of the present disclosure will become apparent from the following detailed description, the accompanying drawings, and the appended claims

### BRIEF DESCRIPTION OF THE DRAWINGS

FIG. 1 is a flow diagram of a motion-based object detection method according to a preferred embodiment of the present disclosure.

FIG. 2 illustrates the process of extracting one or more regions of interest from a video data as input and acquiring a classification result using a deep neural network in the object detection method according to the above preferred embodiment of the present disclosure.

FIG. 3 is a schematic diagram of the architecture of the deep neural network model in the object detection method according to the above preferred embodiment of the present disclosure.

FIG. 4 is a block diagram of a motion-based object detection apparatus according to an embodiment of the present disclosure.

FIG. 5 is a block diagram of an electronic device according to an embodiment of the present disclosure.

### DETAILED DESCRIPTION OF THE PREFERRED EMBODIMENT

The following description is disclosed to enable any person skilled in the art to make and use the present disclosure. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present disclosure.

As mentioned above, deep neural networks (DNNs) have gained greater popularity in object detection applications with higher accuracy than conventional algorithms. A DNN is a computing system made of a number of simple, highly interconnected processing elements (nodes), which process information by their dynamic state to response to external inputs. In particular, the DNNs involved in object detection or recognition application are conventional neural networks (CNNs) in which the connectivity pattern between its nodes is inspired by the organization of animal visual cortex.

Most CNN models for object detection or recognition, such as the CNN model for offline object detection in static images, mainly focus on achieving higher accuracy with deeper and more complicated networks. However, image processing is a computation-intensive task. The huge computational cost caused by the improvement of the accuracy would lead to high latency, which is not conducive to implementations of CNN in embedded terminal products. For example, in a security surveillance system, surveillance devices are required to detect objects of interest (such as potential intruder) in a time-efficient manner such as in real-time based on the images or videos collected. In such scenario, the CNN model are required to be low-latency, low power-consumption and have an accuracy within an acceptable range. In other words, when being utilized in an embedded platform, a relative light-weight network should be constructed to achieve an effective tradeoff between latency and accuracy.

In addition, the computational capability of embedded chips (such as programmable chips) for embedded terminals is not that strong that the CNN would occupy vast part of bandwidth and computation resources, even if cloud computing is taken into consideration. Moreover, since the size of the convolution kernel is usually not matched with word length of a processing unit such as CPU (Central Processing Unit), GPU (Graphics Processing Unit), or VPU (Vision Processing Unit), the standard convolution requires cross-row data fetching, such that a portion of the number acquired by memory access at a time is discarded. Such discontinuous memory access may not only lead to a low efficiency of bandwidth usage, but also affect the cache pre-fetching control of the processor, which may cause cache miss.

In view of the above technical problems, some embodiments the present disclosure is emerged that firstly identifying moving parts in acquired images in order to get one or more regions of interest (ROIs), wherein the ROI are part of the entirety of the acquired images. In other words, the ROIs are less than an entirety of the images, such that the area of the images to be processed is minimized in order to reduce the computational cost thereby. Then, the ROIs are gray processed to reduce input channels thereof, so as to further reduce the computational cost of the convolution operation of a DNN model. After that, the grayscale ROIs are processed by the DNN model to classify the objects contained in the ROIs and obtain an classification result based on the determination whether the objects contained in the ROIs belong to a given categories. In particular, the DNN model is built based on depthwise separable convolution to further reduce the computational cost of the DNN without damaging the accuracy thereof.

Based on some embodiments of present disclosure, some embodiments the present disclosure provide a motion-based object detection method, object detection apparatus and electronic device, wherein the motion-based detection method comprises the steps of:

extracting, by processing acquired first and second images, one or more regions of interest (ROIs);

transforming the one or more ROIs into grayscale; and

acquiring, by processing the grayscale ROIs with a deep neural network (DNN) model to classify the objects contained in the one or more ROIs, a classification result of whether the objects contained in the one or more regions belong to a given categories, wherein the DNN model comprises N (N is a positive integer and ranged from 4-12) depthwise separable convolution layers, wherein each depthwise separable convolution layer comprises a depthwise convolution layer for applying a single filter to each input channel and a pointwise layer for creating an linear combination of the outputs of the depthwise convolution layer to obtain feature maps of the grayscale ROIs. In general, the object detection method has the advantages of low power consumption and being capable of achieving an effective tradeoff between latency and accuracy by gray processing the image to be detected and constructing a specific DNN model.

Illustrative Motion-Based Object Detection Method

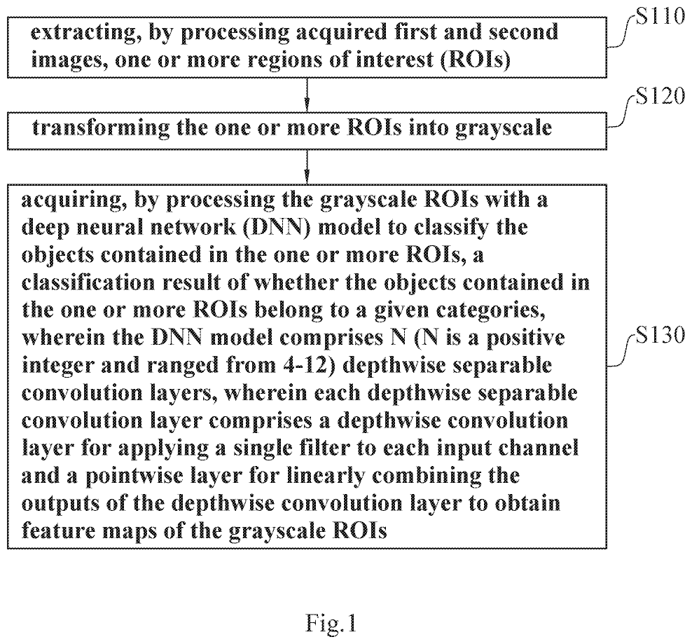

Referring to FIG. 1 of the drawings, a motion-based object detection method according to a preferred embodiment is illustrated, wherein the motion-based object detection method comprises the steps of: S110, extracting, by processing acquired first and second images, one or more regions of interest (ROIs); S120, transforming the one or more ROIs into grayscale; and, S130, acquiring, by processing the grayscale ROIs with a deep neural network (DNN) model to classify the objects contained in the one or more ROIs, a classification result of whether the objects contained in the one or more ROIs belong to a given categories, wherein the DNN model comprises N (N is a positive integer and ranged from 4-12) depthwise separable convolution layers, wherein each depthwise separable convolution layer comprises a depthwise convolution layer for applying a single filter to each input channel and a pointwise layer for linearly combining the outputs of the depthwise convolution layer to obtain feature maps of the grayscale ROIs.

In the step S110, the one or more ROIs are extracted by processing the acquired first and second images. In the image processing field, the region of interest (ROI) refers to an image segment which contains a candidate object of interest which belongs to a certain category.

In the implementation, a suitable method for extracting the region of interest (ROI) should be adopted based on the features of the scenario for which the object detection method is applied. The object detection method is exemplarily applied in security surveillance field as an example in some embodiments of the present disclosure. In a security surveillance system, the objects of interest to be detected are commonly the objects having moving ability (such as humans, human face, animals and vehicles) rather than stationary objects (such as a still background). Therefore, the ROIs may be obtained by identifying the moving parts in the images collected by surveillance equipments (such as surveillance cameras) in the security surveillance system.

More specifically, the moving parts are the image segments having different image contents between images from the perspective of image representation. Therefore, at least two images (the first image and the second image) are required in order to capture the moving parts in the images by comparing the first image and the second image. It is important to mention that the first and second images are taken under the same field of view in a same scene. In other words, the first and the second images have the same background, such that differences generate between the first image and the second image when a moving object intrudes in the scene. Then, the moving parts of the images (the differences between the first image and the second image) are clustered into larger ROIs, In other words, image segments with different image content between the first image and the second image are grouped to form the larger ROIs.

It worth motioning that the first and the second images may be captured by a same image collecting device (such as a surveillance camera) at a certain time interval such as 0.5 seconds. It is appreciated that the time interval between the first image and the second image can be set at any values in some embodiments of the present disclosure. For example, in the aforementioned security surveillance system, the first and the second images may be picked up from a video data and the first and the second images are two consecutive frames in the video data. In other words, the time interval of the first and the second image may be set as the frame rate of the video data in the security surveillance field.

Alternatively, the first image may be set as a standard image which purely contains the scene itself, while the second image is a real-time image of the scene. Any moving objects can be identified by the comparison of the second image captured in real-time and the first image which merely includes the background of the scene. In other words, the first image remains as a reference, and the second image dynamically updates in real-time in such case.

It is important to mention that in the process of collecting the first and the second images by an image collecting apparatus or video collecting apparatus, an unwanted movement (such as translation, rotation and scaling) may occur to the apparatus itself, causing the backgrounds in the first and the second images offset with each other. Accordingly, effective methods should be taken to compensate for the physical movement of the device prior to identifying the moving parts in the first and second images. For example, the second image may be transformed to compensate for the unwanted physical movement based on the position data provided by a positioning sensor (i.e., gyroscope) integrated in the apparatus. The purpose of the transformation of the second image is to align the background in the second image with that in the first image. In other words, prior to the step of identifying the different image regions between the first image and the second image, the method in some embodiments of the present disclosure, further comprises a step of transforming the second image to compensate for the physical movement of an image collecting apparatus during capturing the first and second images.

After being extracted by the motion-based ROI extracting method, the one or more ROIs which are less than an entirety of the first image or the second image are set as the input of a DNN model, such that the computational cost of the DNN model is significantly reduced from the source of the image to be detected. Moreover, since the motion-based ROI extracting method is designed based on the particular scenario for which the object detection method is applied, the candidate objects contained in the extracted ROIs are of high likelihood belonging to the given categories (objects having moving ability). In other words, adopting the motion-based ROI extracting method, the amount of data to be processed can be significantly reduced without damaging the ability of image representation.

In the step S120, the one or more ROIs are transformed into grayscale. In other words, the one or more ROIs are grey processed to transform into grayscale format. Those who skilled in the art would know that most normal images are color images (in RGB format or YUV format) to fully represent the imaged object including illumination and color features. In contrast with grayscale image, color image has multiple channels (i.e. the R, G, B three channels) to store the color information of the imaged object. However, the color feature doesn't do much good in classifying the candidate objects contained in the ROIs, or even unnecessary in some applications. For example, when it is assumed that a given category object of interest is human in the aforementioned security surveillance field, the skin color or the clothing color of the detected people is a misleading feature that should be filtered.

Therefore, the purpose of gray processing the ROIs is to filter the color information in the ROIs so as to not only reduce the computational cost of the DNN model but also to effectively prevent the color information adversely affecting object detection accuracy.

In order to further minimize the computational cost of the DNN model, the one or more ROIs may be scaled to particular sizes, i.e. 128*128 pixels. In practice, the size reduction of ROIs depends on the accuracy requirement of the object detection method and the architecture of the DNN model. In other words, the scaled size of the ROIs can be adjusted corresponding to the complexity of the DNN model and the accuracy requirements of the object detection method, which is not a limitation in some embodiments of the present disclosure.

For ease of better description and understanding, the processes of gray-scaling the ROIs and scaling the sizes of the ROIs are defined as a normalization process of the ROIs in some embodiments of the present disclosure. In other words, after being extracted by the motion-based ROI extracting method, the ROIs are normalized: reduced to grayscale and scaled to a particular size.

In the step S130, a classification result of whether the objects contained in the one or more regions belong to a given categories is acquired by processing the grayscale ROIs with a deep neural network (DNN) model for classifying the objects contained in the one or more ROIs, wherein the DNN model comprises N (N is a positive integer and ranged from 4-12) depthwise separable convolution layers, and each depthwise separable convolution layer comprises a depthwise convolution layer for applying a single filter to each input channel and a pointwise layer for linearly combining the outputs of the depthwise convolution layer to obtain a feature map.

As mentioned above, when being applied into embedded platforms, the DNN model should be constructed light-weight and able to achieve an effective tradeoff between latency and accuracy. Those skilled in the art would know that there are mainly two approaches to shrink and optimize the DNN: one is knowledge distillation and the other is model compressing. The knowledge distillation refers to taking advantage of important features extracted by training a larger and more complex network to train a smaller network so as to reduce the data dependency of the neural network models. The model compressing is the mainstream way for network shirking and optimization, which mainly focus on network-structure pruning and the convolution optimization. The pruning of the network structure refers to cutting the less-important weights in the DNN model to remove part of redundant connections. In particular, the DNN model involved in some embodiments of the present disclosure is shrunken and optimized by adjusting convolution operations thereof to make it meet the requirements of being applied in embedded platforms.

More specifically, the DNN model involved in some embodiments of the present disclosure is constructed based on the depthwise separable convolution layers, wherein the depthwise separable convolution layer uses depthwise separable convolution in place of standard convolution to solve the problems of low computational efficiency and large parameter size. The depthwise separable convolution is a form of factorized convolution which factorize a standard convolution into a depthwise convolution and a 1×1 convolution called a pointwise convolution, wherein the depthwise convolution applies a single filter to each input channel and the pointwise convolution is used to create a linear combination the output of the depthwise convolution to obtain updated feature maps. In other words, each depthwise separable convolution layer comprises a depthwise convolution layer for applying a single filter to each input channel and a pointwise layer for linearly combining the outputs of the depthwise convolution layer to obtain a feature map in some embodiments of the present disclosure.

The computational cost and the size of the DNN model can be significantly reduced based on the depthwise separable convolution. Also, the separable structure of the depthwise separable convolution layer is friendly supportive to the hardware acceleration instructions of a processor such as CPU, GPU and VPU. Those who skilled in the art would know that most modern processor designs include SIMD (Single instruction multiple data) instructions to improve the performance of data processing thereof. In computation-intensive task such as image processing, the SIMD instructions are well suited to optimize the data processing rate of the DNN model. However, since the size of the convolution kernel in standard convolution is not matched with word length of the processor, the standard convolution requires cross-row data fetching that part of the number acquired by memory access at a time must be discarded. Such discontinuous memory access may not only lead to a low efficiency of bandwidth usage, but also affect the cache pre-fetching control of the processor causing cache miss.

Compared with the standard convolution, the depthwise separable convolution layer with a separable structure has less convolutions, such that the times of memory access would be significantly reduced and also the likelihood of Cache Miss is also significantly reduced. Meanwhile, the 1×1 convolution operation performed on the pointwise convolution layer is a vector multiplication operation which is extremely suitable for SMID's data fetching mechanism, so that the bandwidth and the processor can be effectively utilized. In other words, the DNN model on a basis of depthwise separable convolution has a relatively smaller computational cost and is also supportive to hardware acceleration, thereby increasing the speed of the object detection and reducing the power consumption thereof.

In some embodiments of the present disclosure, the DNN model comprises N depthwise separable convolution layers, wherein the N is a positive integer and ranged from 4-12. In practice, the number of the depthwise separable convolution layers is determined by the requirements for latency and accuracy in specific scenarios. In particular, the DNN model may comprises five depthwise separable convolution layers when the object detection method is applied in the aforementioned security surveillance field. The five depthwise separable convolution layers are listed as first, second, third, fourth and fifth depthwise separable convolution layers, wherein the grayscale ROIs are inputted into the first depthwise separable convolution layer.

More detailedly, the first depthwise separable convolution layer comprises 32 filters of size 3×3 in the depthwise convolution layer and filters of size 1×1 in a corresponding number in the pointwise convolution layer. The second depthwise separable convolution layer connected to the first depthwise separable convolution layer comprises 64 filters of size 3×3 in the depthwise convolution layer and filters of size 1×1 in a corresponding number in the pointwise convolution layer. The third depthwise separable convolution layer connected to the second depthwise separable convolution layer comprises 128 filters of size 3×3 in the depthwise convolution layer and filters of size 1×1 in a corresponding number in the pointwise convolution layer. The fourth depthwise separable convolution layer connected to the third depthwise separable convolution layer comprises 256 filters of size 3×3 in the depthwise convolution layer and filters of size 1×1 in a corresponding number in the pointwise convolution layer. The five depthwise separable convolution layer connected to the fourth depthwise separable convolution layer comprises 256 filters of size 3×3 in the depthwise convolution layer and filters of size 1×1 in a corresponding number in the pointwise convolution layer.

After obtaining the feature maps of the grayscale ROIs by a predetermined number of depthwise separable convolution layers, the DNN model further classify the candidate objects contained in the grayscale ROIs and generate a classification result based on a determination of whether the objects contained in the ROIs belong to a given categories. In particular, the deed of classifying the candidate objects contained in the grayscale ROIs is accomplished by a Softmax layer of the DNN model.

A classification result is generated based on the determination of whether the objects contained in the ROIs belongs to a given categories. More specifically, when it is determined that one of the objects contained in ROIs belongs to the given categories, an indication of a presence of a satisfied object contained in the ROIs may be generated. In particular, the indication may be the name of the category of the satisfied object contained in the ROIs. Or, the indication may be a certain level of confidence that the satisfied object contained in the ROIs is of a certain category. Alternatively, the indication may be a switch signal indicating of a presence of the satisfied object in the ROIs. It worth mentioning that the indication can be adjusted based on specific requirements in the application scenarios, which is not a limitation in the present disclosure.

When it is determined that no objects contained in ROIs belongs to the given categories, the same process of extracting the one or more ROIs and processing the ROIs with the DNN model to acquire a classification result may be looped until an satisfied object that belongs to the given categories is found or looped for a predetermined times alternatively.

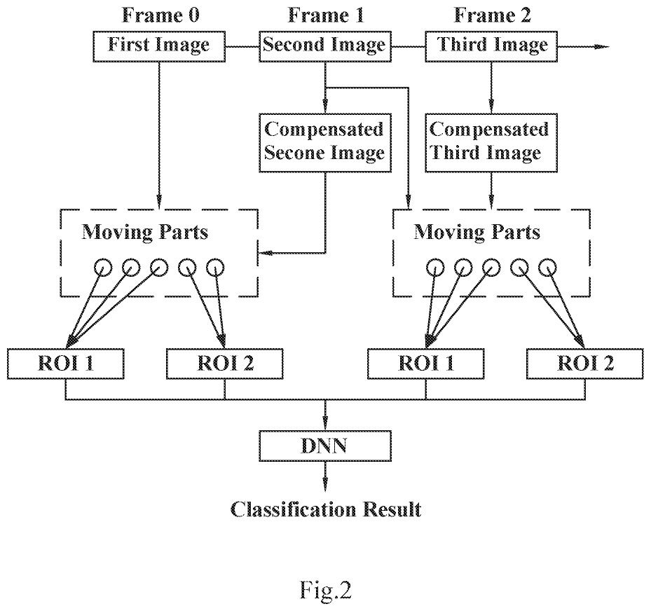

Here, taking the first image and the second image are two consecutive frame of a video data as an example to illustrate this situation. As shown in FIG. 2, when it is determined that no object contained in ROIs extracted from the first and the second images of the given categories is found, a third image may further be provided and processed by the motion-based ROI extracting method tighter with the second image to obtain another ROIs, wherein the third image and the second image are two consecutive frames from the same video. Similarly, the new ROIs are further to be processed by the DNN model to acquire another classification result. The same process may be repeated until a positive frame that contains an object of a certain category is found or just repeated for a certain times. In practice, the loop times of the ROI extraction and acquiring a classification result may be determined by a time window (such as 15 sec) of the video data. Alternatively, in response to a negative determination, a negative indication may be generated to indicate that no satisfied object is found in the fixed time window of the video data.

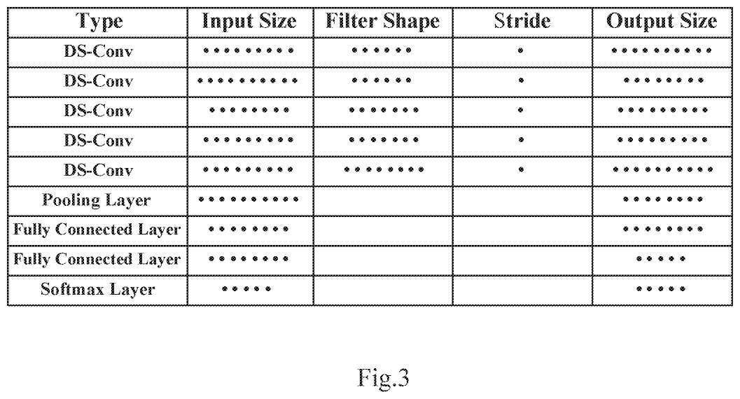

FIG. 3 is a schematic diagram of the architecture of the DNN model according to some embodiments of the present disclosure, wherein the input of the DNN model is exemplarily set as the grayscale ROIs with sizes of 128×128 pixels. As shown in the FIG. 3, the DNN model comprises five depthwise separable convolution layers, one pooling layer, two fully connected layers and one Softmax layer. The five depthwise separable convolution layers are configured for acquiring feature maps of the grayscale ROIs (the input), wherein 1024 feature maps of size 16×16 are outputted at the fifth depthwise separable convolution. The 1024 feature maps sized in 16×16 are transformed into a vector of length 1024 by the pooling layer using max pooling. The fully connected layer is fully connected to the previous layer. The vector of length 1024 is transformed into a vector of length N at the second fully connected layer, wherein the N is the number of categories to be predicted. The Softmax layer is applied to the previous fully connected layer of the N nodes, resulting in a distribution of N probabilities, where the category of the highest probability is usually selected as the category of the objects contained in the RIOs.

It is worth mentioning that the DNN model should be well-trained to adjust the weights of the parameters thereof before the DNN model is put into service for object detection or recognition tasks as mentioned in some embodiments of the present disclosure.

It is appreciated that though the object detection method is described as being applied in the security surveillance field as an illustrative example in some embodiments of the present disclosure, those who skilled in the art would easily understand that the motion-based object detection method may also be applied in embedded platforms in any other fields, which is not a limitation in the present disclosure. It is appreciated that the architecture of the DNN model, especially the number of the depthwise separable convolution layers, and the normalization of the ROIs should be adjusted corresponding to the specific requirements in the other application scenarios.

Illustrative Data Processing Device

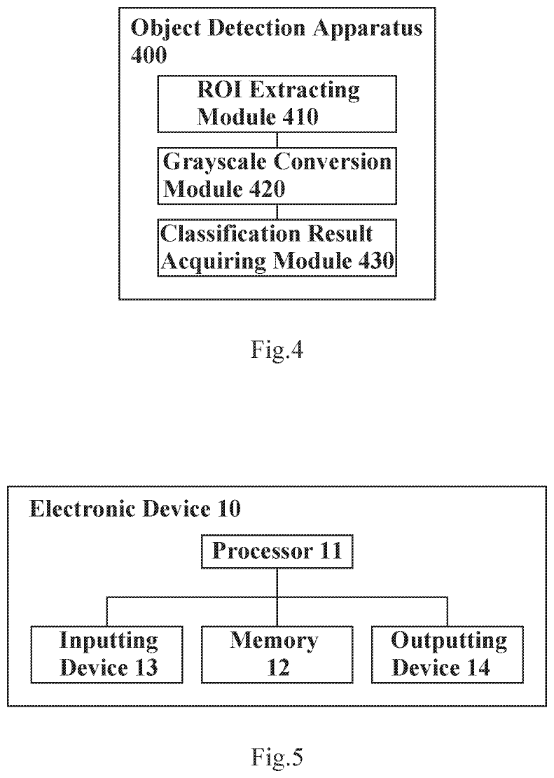

FIG. 4 is a block diagram of a motion-based object detection apparatus according to an embodiment of the present disclosure. As shown in FIG. 4 of the drawings, the object detection apparatus 400 which is an data processing apparatus for object detection, comprises a region of interest extraction module 410 for extracting, by processing acquired first and second images, one or more regions of interest (ROIs); a grayscale transformation module 420 for transforming the one or more ROIs into grayscale; and, a classification result acquiring module 430 for acquiring, by processing the grayscale ROIs with a deep neural network (DNN) model to classify the objects contained in the one or more ROIs, a classification result of whether the objects contained in the one or more regions belong to a given categories, wherein the DNN model comprises N (N is a positive integer and ranged from 4-12) depthwise separable convolution layers, wherein each depthwise separable convolution layer comprises a depthwise convolution layer for applying a single filter to each input channel and a pointwise layer for linearly combining the outputs of the depthwise convolution layer to obtain feature maps of the grayscale ROIs.

In one embodiment of the present disclosure, the classification result acquiring module 430 is further configured for determining whether any one of the objects contained in the one or more ROIs belongs to the given categories and generating, responsive to the determination, an indication of a presence of the objects contained in the one or more ROIs belonging to the given categories.

In one embodiment of the present disclosure, the region of interest extraction module 410 is further configured for identifying different image regions between the first image and the second image and grouping the different image regions between the first image and the second image into the one or more ROIs.

In one embodiment of the present disclosure, the region of interest extraction module 410 is further configured for transforming the second image to compensate for the physical movement of an image collecting apparatus when capturing the first and second images.

In one embodiment of the present disclosure, the first and second images are two consecutive frames of a video.

In one embodiment of the present disclosure, the one or more ROIs are scaled to size 128*128 pixels.

In one embodiment of the present disclosure, the DNN model comprise five depthwise separable convolution layers.

Those skilled in the art could easily understand that the functions and operations of the modules in the object detection apparatus have been detailedly illustrated in the aforementioned description of the objection detection method. Therefore, duplicate description is omitted.

It is appreciated that the object detection apparatus in some embodiments of the present disclosure may be implemented in various terminal devices, such as a surveillance device. Moreover, the object detection apparatus may be integrated into the terminal devices as a software module and/or hardware module. For example, the object detection apparatus may be embodied as a software module in the operating system of the terminal devices, or may be embodied as an application program developed for the terminal devices. Of course, the object detection apparatus itself may also be one of the hardwire modules of the terminal device.

Alternatively, the object device and the terminal device may be separate devices. In such case, the object detection apparatus may communicate with the terminal device through a connecting wire or wireless network and transmit information under certain data transfer protocol.

Illustrative Electronic Device

FIG. 5 is a block diagram of an electronic device according to an embodiment of the present disclosure. As shown in FIG. 5, the electronic device comprises 10 at least one processor 11 and a memory 12.

The processor 11 may be embodied as a central processing unit (CPU) or other form of processing units having data processing capabilities and/or instruction execution capabilities, wherein the processor may control other components of the electronic device 10 to perform desired functions.

The Memory 12 may comprise one or more computer program product, wherein the computer program product may include a computer readable storage medium (or media), A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. One or more program instructions are stored on the computer readable storage medium and run by the processor 11 to perform the functions of the motion-based object detection method in some embodiments of the present disclosure.

Further, the electronic device 10 may comprises an inputting device 13 and an outputting device 14 which are interconnected by a bus system and/or other forms of connection mechanisms (not shown). For example, the inputting device 13 may be embodied as a camera module to capture images or videos. The outputting device 14 may output various kinds of information such as the classification result. The outputting device 14 may be embodied as, a display, a speaker, a printer, or any other remotely-connected outputting devices.

It's appreciated that for the sake of simplicity, only part of the components of the electronic device 10 related in some embodiments of the present disclosure is shown in FIG. 5, and components such as buses, input/output interfaces, and the like are omitted. In addition, the electronic device 10 may further comprise any other suitable components depending on the requirements in specific applications.

Illustrative Computer Program Product

Some embodiments of present disclosure may be a apparatus, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of some embodiments of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, devices, and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of devices, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

One skilled in the art will understand that the embodiment of the present disclosure as shown in the drawings and described above is exemplary only and not intended to be limiting.

It will thus be seen that the objects of the present disclosure have been fully and effectively accomplished. The embodiments have been shown and described for the purposes of illustrating the functional and structural principles of the present disclosure and is subject to change without departure from such principles. Therefore, this disclosure includes all modifications encompassed within the spirit and scope of the following claims.

1. A motion-based object detection method, comprising:
extracting, by processing acquired first and second images, one or more regions of interest (ROIs);
transforming the one or more ROIs into grayscale; and
acquiring, by processing the grayscale ROIs with a deep neural network (DNN) model to classify objects contained in the one or more ROIs, a classification result of whether the objects contained in the one or more ROIs belong to a given categories, wherein the DNN model comprises N depthwise separable convolution layers, wherein each depthwise separable convolution layer comprises a depthwise convolution layer for applying a single filter to each input channel and a pointwise layer for linearly combining outputs of the depthwise convolution layer to obtain feature maps of the grayscale ROIs, wherein N is a positive integer and ranged from 4-12.

2. The motion-based object detection method, as recited in claim 1, wherein the step of acquiring a classification result further comprises the steps of:
determining whether any one of the objects contained in the one or more ROIs belong to the given categories; and
generating, responsive to the determination, an indication of a presence of the objects contained in the one or more ROIs belonging to the given categories.

3. The motion-based object detection method, as recited in claim 2, wherein the step of extracting the one or more ROIs, comprises the steps of:
identifying different image regions between the first image and the second image; and
grouping the different image regions between the first image and the second image into the one or more ROIs.

4. The motion-based object detection method, as recited in claim 3, wherein prior to the step of identifying the different image regions between the first image and the second image, the method further comprising the step of:
transforming the second image to compensate for physical movement of an image collecting apparatus when capturing the first image and the second image.

5. The motion-based object detection method, as recited in claim 4, wherein the first and second images are two consecutive frames of a video.

6. The motion-based object detection method, as recited in claim 5, wherein the one or more ROIs are scaled to size 128*128 pixels.

7. The motion-based object detection method, as recited in claim 6, wherein the DNN model comprise five depthwise separable convolution layers.

8. An object detection apparatus, comprising:
a region of interest (ROI) extractor configured to extract, by processing acquired first and second images, one or more ROIs;
a grayscale transformer configured to transform the one or more ROIs into grayscale; and
a classification result acquirer configured to acquire, by processing the grayscale ROIs with a deep neural network (DNN) model to classify objects contained in the one or more ROIs, a classification result of whether the objects contained in the one or more ROIs belong to a given categories, wherein the DNN model comprises N depthwise separable convolution layers, wherein each depthwise separable convolution layer comprises a depthwise convolution layer for applying a single filter to each input channel and a pointwise layer for linearly combining outputs of the depthwise convolution layer to obtain feature maps of the grayscale ROIs, wherein N is a positive integer and ranged from 4-12.

9. The object detection apparatus, as recited in claim 8, wherein the classification result acquirer is further configured to:
determine whether any one of the objects contained in the one or more ROIs belong to the given categories; and
generate, responsive to the determination, an indication of a presence of the objects contained in the one or more ROIs belonging to the given categories.

10. The object detection apparatus, as recited in claim 9, wherein the region of interest extractor is further configured to:
identify different image regions between the first image and the second image; and
group the different image regions between the first image and the second image into the one or more ROIs.

11. The object detection apparatus, as recited in claim 10, wherein the region of interest extractor is further configured to:
transform the second image to compensate for physical movement of an image collecting apparatus when capturing the first image and the second image.

12. The object detection apparatus, as recited in claim 11, wherein the first and second images are two consecutive frames of a video.

13. The object detection apparatus, as recited in claim 12, wherein the one or more ROIs are scaled to size 128*128 pixels.

14. The object detection apparatus, as recited in claim 13, wherein the DNN model comprises five depthwise separable convolution layers.

15. (canceled)

16. A non-transitory computer storage medium that, when executed by a processor, causes the processor to perform the following method:
processing acquired first and second images, one or more ROIs;
transforming the one or more ROIs into grayscale; and
acquiring, by processing the grayscale ROIs with a deep neural network (DNN) model to classify objects contained in the one or more ROIs, a classification result of whether the objects contained in the one or more ROIs belong to a given categories, wherein the DNN model comprises N depthwise separable convolution layers, wherein each depthwise separable convolution layer comprises a depthwise convolution layer for applying a single filter to each input channel and a pointwise layer for linearly combining outputs of the depthwise convolution layer to obtain feature maps of the grayscale ROIs, wherein N is a positive integer and ranged from 4-12.
